(19) United States
(12) Patent Application Publication
(10) Pub. No.: US 2025/0371223 A1
(43) Pub. Date: Dec. 4, 2025

(54) SIMULATING PHYSICAL ENVIRONMENTS WITH DISCONTINUOUS DYNAMICS USING GRAPH NEURAL NETWORKS

(71) Applicant: DeepMind Technologies Limited, London (GB)

(72) Inventors: Kelsey Rebecca Allen, London (GB); Tatiana Lopez Guevara, Edinburgh (GB); Tobias Pfaff, London (GB); Alvaro Sanchez, London (GB); Yulia Rubanova, London (GB); Kimberly Stachenfeld, London (GB); Peter William Battaglia, London (GB)

(21) Appl. No.: 18/874,871

(22) PCT Filed: Jun. 15, 2023
(86) PCT No.: PCT/EP2023/066187

§ 371 Date: Dec. 13, 2024

Related U.S. Application Data
(60) Provisional application No. 63/352,634, filed on Jun. 15, 2022.

(51) Int. Cl. G06F 30/27; G06F 119/12

(52) U.S. Cl. CPC G06F 30/27; G06F 2119/12

(57) ABSTRACT

This specification describes a simulation system that performs simulations of physical environments using a graph neural network. At each of one or more time steps in a sequence of time steps in a given time interval, the system can process a representation of a current state of the physical environment at the current time step using the graph neural network to generate a prediction of a next state of the physical environment at the next time step. Generally, the environment has discontinuous dynamics at one or more time points during the time interval.

### CROSS-REFERENCE TO RELATED APPLICATION

This application claims priority to U.S. Provisional Application No. 63/352,634, filed on Jun. 15, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a simulation system implemented as computer programs on one or more computers in one or more locations that performs simulations of physical environments using a graph neural network. Generally, the simulation system simulates the states of physical environments that can have discontinuous dynamics. These discontinuous dynamics can be caused by rigid collisions, by frictional transitions, or both.

Simulations generated by the simulation system described in this specification (e.g., that characterize predicted states of a physical environment over a sequence of time steps) can be used for any of a variety of purposes.

In some cases, a visual representation of the simulation may be generated, e.g., as a video, and provided to a user of the simulation system.

In some cases, an agent (e.g., a reinforcement learning agent) interacting with a physical environment may use the simulation system to generate one or more simulations of the environment that simulate the effects of the agent performing various actions in the environment. In these cases, the agent may use the simulations of the environment as part of determining whether to perform certain actions in the environment.

In some cases, the simulation performed by the system can be used to evaluate a control policy for an agent interacting with objects in the real-world environment, i.e., the policy can be evaluated by using the simulated states of the physical environment. For example, a learned control policy can be evaluated using the simulation system prior to being deployed for controlling the agent in the real-world. This can save wear and tear on the mechanical agent and prevent poorly performing policies from causing the agent to perform dangerous or otherwise harmful actions.

In some cases, the simulation performed by the system can be used to train a control policy for an agent interacting with objects in the real-world environment, i.e., the policy can be trained through reinforcement learning or other training technique on training data generated by simulating the real-world using the simulated states of the physical environment. For example, a control policy can be learned using the simulation system prior to being deployed for controlling the agent in the real-world. This can save wear and tear on the mechanical agent and prevent poorly performing policies from causing the agent to perform dangerous or otherwise harmful actions.

In one aspect there is described a method performed by one or more data processing apparatus for simulating states of a physical (real-world) environment. The method involves obtaining data defining the state of the physical environment at one or more initial time steps. The data defining the state of the physical environment at a given time step represents a mesh of the environment at the given step. The mesh comprises a plurality of mesh nodes and a plurality of mesh edges. The data defining the state of the environment comprises respective mesh node features for each of the mesh nodes and respective mesh edge features for each of the mesh edges.

For example, the state of the physical environment may comprise a state defined by the relative or absolute position and/or motion of one or more objects in the environment. Such an object can be a rigid object, i.e. one which does not substantially deform under an applied force, but the described techniques are also applicable to resilient objects, i.e. objects able to undergo elastic deformation. The mesh of the environment can be defined by, e.g., a relative or absolute position of each node of the mesh in the environment. For example, for the or each object in the environment a node of the mesh may define a point on the object and the mesh may have edges, where a mesh edge between two mesh nodes defines that the two mesh nodes are part of a shared (the same) face of the object. For the or each object the mesh may be obtained from an initial mesh of the (undeformed) object and applying a translation and/or rotation to a center of mass of the object. In implementations the mesh nodes define nodes of a graph and edges between the mesh nodes define edges of the graph: the graph is processed by a graph neural network. In some implementations, counterintuitively, the mesh (graph) node features for a node define the velocity of the node, and optionally a distance to a boundary, e.g. a rigid boundary with which the object(s) will interact, and the mesh (graph) edge features for an edge define positions of the nodes. The mesh node features may be encoded into node embeddings for nodes of the graph, and the mesh edge features may be encoded into edge embeddings for edges of the graph. The velocity may be a finite difference velocity determined from a difference between the node position over an input history of one or more time steps. The edge features defining positions of the nodes may comprise, for a pair of nodes i, j connected by an edge, a vector of relative displacement between the nodes i and j, dᵢⱼ (and optionally also ∥dᵢⱼ∥). The edge features may also include a displacement between these nodes on the undeformed initial mesh,

$${d}_{ij}^{U}$$

(and optionally also

$$‖ {d}_{i j}^{U} ‖ ) ;$$

this can help to retain the object shape. Such node and edge feature representations can be useful as they provide a local and translation-equivariant encoding of the state of the environment.

The method also involves generating data defining a respective simulated state of the physical environment at each current time step in a time interval following the one or more initial time steps. In implementations the environment, e.g. motion of the one or more objects in the environment, has discontinuous dynamics at one or more time points during the time interval. Here “discontinuous dynamics” can refer to a discontinuous (rather than smooth) change in the motion, e.g. velocity of an object, e.g. a rigid object.

In implementations of the method generating the data defining a respective simulated state comprises, at each current time step in the time interval, generating a representation of the state of the physical environment at the current time step, the representation comprising a respective current node embedding for each of the mesh nodes and a respective current edge embedding for each of the mesh edges. The data defining the representation is processed using a graph neural network to update the current node embedding of each mesh node and the current edge embedding of each mesh edge. The graph neural network can comprise one or more edge updating sub neural networks to update the edges of the graph, specifically the edge embeddings, and one or more node updating sub neural networks to update the nodes of the graph, specifically the node embeddings, based on the updated edges.

In implementations, after the updating the respective current node embedding for each mesh node in the mesh is used to generate a respective dynamics feature corresponding to each mesh node, e.g. by processing the current node embedding using a decoder sub-neural network of the graph neural network. In implementations the dynamics feature comprises a node velocity or acceleration prediction, e.g. a finite-difference acceleration estimate, that can be integrated once or twice, respectively, e.g. with an Euler integrator, to obtain a position estimate for the node.

In implementations the method determines a simulated state of the physical environment at a next time step based on the dynamics features corresponding to the mesh nodes. In general the method can roll out the simulation for multiple time steps in which case the simulated state of the physical environment at the next time step is also based on the (simulated) the state of the physical environment at the current time step.

In implementations the method uses shape matching during such a rollout to reduce the accumulation of positional errors. For example, after each time step the method can fit a (rigid) transformation, i.e. a translation and/or rotation of the undeformed object mesh, to the predicted node positions, and then re-project the nodes to the transformed mesh to enforce shape consistency.

Throughout this specification, an “embedding” of an entity can refer to a representation of the entity as an ordered collection of numerical values, e.g., a vector or matrix of numerical values. An embedding of an entity can be generated, e.g., as the output of a neural network that processes data characterizing the entity.

The subject matter described in this specification can be implemented in particular embodiments so as to realize one or more of the following advantages.

Realistic simulators of complex physics are invaluable to many scientific and engineering disciplines. However conventional simulation systems can be very expensive to create and use. Building a conventional simulator can entail years of engineering effort, and often must trade off generality for accuracy in a narrow range of settings. Furthermore, high-quality simulators require substantial computational resources, which makes scaling up prohibitive. The simulation system described in this specification can generate simulations of complex physical environments over large numbers of time steps with greater accuracy and using fewer computational resources (e.g., memory and computing power) than some conventional simulation systems. In certain situations, the simulation system can generate simulations one or more orders of magnitude faster than conventional simulation systems. For example, the simulation system can predict the state of a physical environment at a next time step by a single pass through a neural network, while conventional simulation systems may be required to perform a separate optimization at each time step.

The simulation system generates simulations using a graph neural network that can learn to simulate complex physics directly from training data, and can generalize implicitly learned physics principles to accurately simulate a broader range of physical environments under different conditions than are directly represented in the training data. This also allows the system to generalize to larger and more complex settings than those used in training. In contrast, some conventional simulation systems require physics principles to be explicitly programmed, and must be manually adapted for the specific characteristics of each environment being simulated.

The simulation system can perform mesh-based simulations, e.g., where the state of the physical environment at each time step is represented by a mesh. Performing mesh-based simulations can enable the simulation system to simulate certain physical environments more accurately than would otherwise be possible, e.g., physical environments that include deforming surfaces or volumes that are challenging to model as a cloud of disconnected particles. Performing mesh-based simulations can also enable the simulation system to dynamically adapt the resolution of the mesh over the course of the simulation, e.g., to increase the resolution of the mesh at parts of the simulation where more accuracy is required, thereby increasing the overall accuracy of the simulation. By dynamically adapting the resolution of the mesh, the simulation system is able to generate a simulation of a given accuracy using fewer computational resources, when compared to some conventional simulation systems.

More specifically, many simulation scenarios require the simulation system to accurately model discontinuous dynamics, such as rigid contact or switching motion modes, within the underlying physical environment. Prior to this work, it has been believed that deep networks are incapable of accurately modeling rigid-body dynamics without explicit modules for handling contacts, due to the continuous nature of how deep networks are parameterized. This specification shows that such dynamics can be modeled with a general-purpose graph network simulator, with no contact-specific assumptions. That is, the described graph network based simulator can accurately learn and predict contact discontinuities. Furthermore, contact dynamics learned by the graph network simulators can actually model real-world object trajectories more accurately than highly engineered, special-purpose simulators. For example, the described simulator can capture real-world cube tossing trajectories more accurately than highly engineered robotics simulators, even when provided with only 8-16 trajectories for training. Overall, this shows that rigid-body dynamics do not pose a fundamental challenge for deep networks with the described appropriate general architecture and parameterization. Thus, the described techniques can be used, e.g., in place of a traditional simulator as described above, even when accurately modeling discontinuous dynamics is required.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example physical environment simulation system.

FIG. 2 illustrates example operations of a physical environment simulation system.

FIG. 3 illustrates an example simulation of a physical environment relative to the ground truth states of the physical environment.

FIG. 4A is a flow diagram of an example process for simulating a physical environment.

FIG. 4B illustrates the shape matching process.

FIG. 5 illustrates the sensitivity of the described techniques to initial conditions.

Like reference numbers and designations in the various drawings indicate like elements.

### DETAILED DESCRIPTION

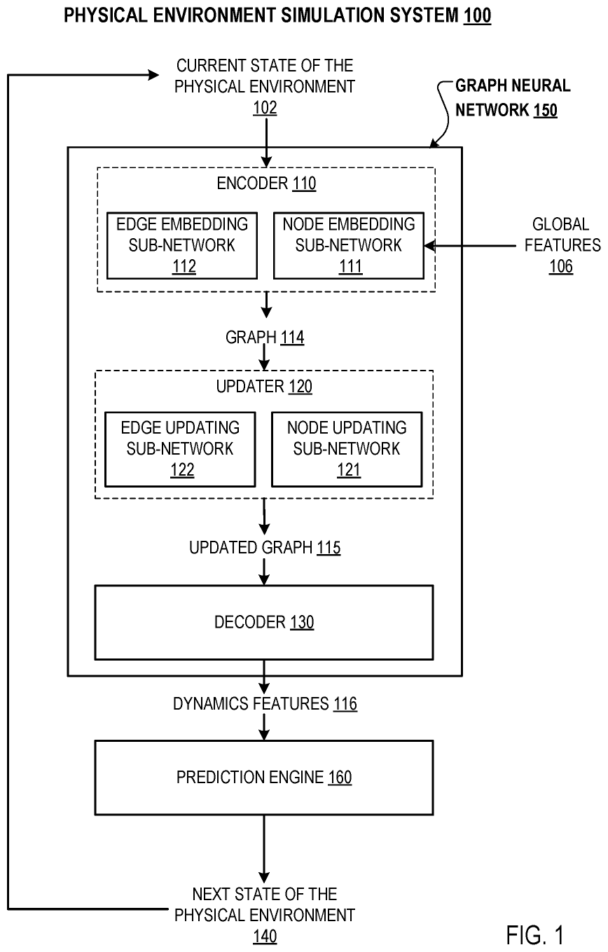

FIG. 1 is a block diagram of an example physical environment simulation system 100 that can simulate a state of a physical environment. The physical environment simulation system 100 is an example of a system implemented as computer programs on one or more computers in one or more locations in which the systems, components, and techniques described below are implemented.

A “physical environment” generally refers to any type of physical system including, e.g., a fluid, a rigid solid, a deformable material, any other type of physical system or a combination thereof.

A “simulation” of the physical environment can include a respective simulated state of the environment at each time step in a sequence of time steps.

The state of the physical environment at a time step can be represented as a mesh, as will be described in more detail below.

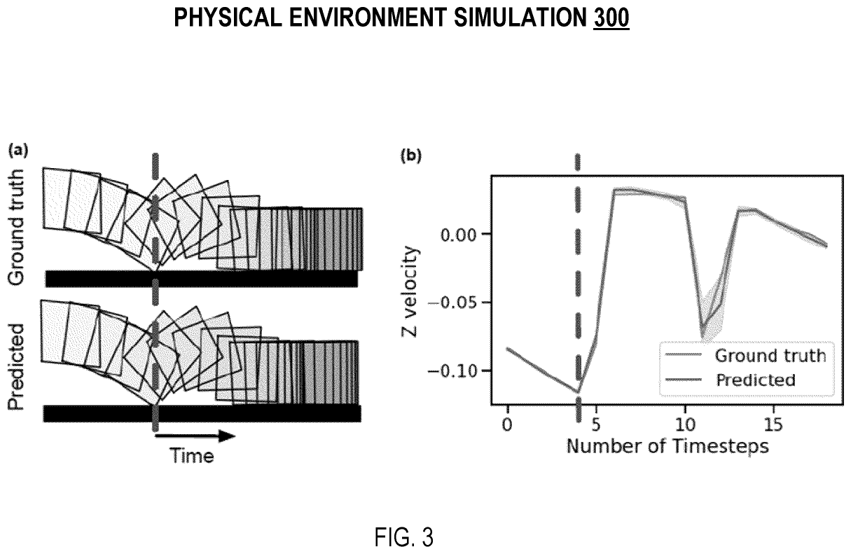

The state of the environment at one or more initial time steps can be provided as an input to the physical environment simulation system 100, e.g., by a user of the system 100. At each time step in a sequence of time steps, the system 100 can process the input and generate a prediction of the state of the physical environment at the next time step 140. An example simulation of a physical environment is shown in FIG. 3.

As a particular example, the physical environment being simulated can be a physical environment that is being interacted with by an agent, (e.g., a reinforcement learning agent, e.g., a robot, an autonomous vehicle, or other mechanical agent).

That is, an agent interacting with a physical environment may use the simulation system to generate one or more simulations of the environment that simulate the effects of the agent performing various actions in the environment. In these cases, the agent may use the simulations of the environment as part of determining whether to perform certain actions in the environment, e.g., as part of a planning system employed by a control system for the agent.

In some cases, the simulation performed by the system can be used to evaluate a control policy for an agent interacting with objects in the real-world environment, i.e., the policy can be evaluated by using the simulated states of the physical environment. For example, a learned control policy can be evaluated using the simulation system prior to being deployed for controlling the agent in the real-world. This can save wear and tear on the mechanical agent and prevent poorly performing policies from causing the agent to perform dangerous or otherwise harmful actions.

In some cases, the simulation performed by the system can be used to train a control policy for an agent interacting with objects in the real-world environment, i.e., the policy can be trained through reinforcement learning or other training technique on training data generated by simulating the real-world using the simulated states of the physical environment. For example, a control policy can be learned using the simulation system prior to being deployed for controlling the agent in the real-world. This can save wear and tear on the mechanical agent and prevent poorly performing policies from causing the agent to perform dangerous or otherwise harmful actions.

That is, a simulation as described herein, of one or more (rigid) objects moving in a physical, real-world environment, can be used to train or evaluate a control policy for an agent, e.g. a mechanical agent such as a robot, by simulating actions of the agent in the environment, predicting the simulated state of the physical environment at a future time step, and using the simulated state of the physical environment at the future time step to train or evaluate the control policy. The control policy may be implemented by a control system of the agent, e.g. a trainable control system, that is configured to receive observations from one or more sensors characterizing a state of the environment in which the agent is operating, e.g. a position or motion of a part of the agent and/or an object to be manipulated by the agent, and in response to provide a control output to control a mechanical action of the agent in the environment, e.g. to perform a particular task in the environment such as moving an object within the environment or navigating within the environment. After the control policy has been trained or evaluated the control policy may be deployed for controlling the agent in the physical environment, e.g. by using the trained or evaluated control system of the agent to control the agent to perform actions in the real-world environment, e.g. to perform the particular task.

For example, a control system of the robot can receive observations from one or more sensors characterizing a state of the environment in which the robot is operating. e.g. a position or motion of a part of the robot and/or object to be manipulated, and can use the simulated state of the physical (real-world) environment at a future time step, to control the or another part of the robot. e.g. to perform a particular task in the environment such as moving an object within the environment or navigating within the environment.

Generally, robots or other agents interacting with a physical environment can encounter many different types of dynamics during the interaction that need to be accurately modeled by the system.

For example, agents interacting with a physical environment can encounter discontinuous dynamics at various points during their interaction.

As a particular example, many tasks in robotics, from locomotion to manipulation, require making and breaking contact with rigid objects. This phenomenon is known to be discontinuous, as the spatial and temporal scales on which rigid bodies deform during contact can be imperceptibly small. That is, rigid contact (contact between rigid surfaces/objects) occurring within the environment can result in discontinuous dynamics within the environment.

In some cases frictional transitions such as stiction that occur in the environment can result in discontinuous dynamics, e.g. resulting in a discontinuous transition between a stationary state of an object in contact with a surface and motion of the object sliding over the surface (slip-stick transitions).

The system generates simulations that accurately model the environment even in the presence of discontinuous dynamics. For example, a part of a robot such as a hand or gripper may need to move towards an object to be manipulated, and it can be useful to simulate the effect of the part of the robot coming into contact with the object. The techniques described herein can be used to predict the motion of the object and/or robot part as a result of relative motion and then contact between the two, e.g. by modelling the robot part as a boundary or as another object in the environment. As another example a part of a robot such as leg or arm of the robot may move towards a boundary such as a floor or wall, and it can be useful to simulate the effect of the part of the robot coming into contact with the boundary, e.g. to predict the subsequent motion of the robot part.

In general the simulation can be used to control an action of the robot, e.g. motion of the part of the robot, e.g. based on model predictive control. For example, a control system of the robot can receive observations from one or more sensors characterizing a state of the environment in which the robot is operating, e.g. a position or motion of a part of the robot and/or object to be manipulated, and can use the simulated state of the physical (real-world) environment at a future time step, to control the or another part of the robot, e.g. to perform a particular task in the environment such as moving an object within the environment or navigating within the environment.

During the simulation, the system represents the physical environment as a mesh that can, e.g., span the whole of the physical environment, or represent respective surfaces of one or more objects in the environment.

The simulation system 100 can process a current state of the physical environment 102 at a current time step using a graph neural network 150 to predict the next state of the physical environment 140 at a next time step.

Generally, the simulation system 100 can model the dynamics of the physical environment by mapping the current state X of the physical environment at time/onto the next state of the physical environment at time t+1.

The graph neural network 150 of the simulation system 100 can include an encoder module 110, an updater module 120, a decoder module 130.

The encoder 110 can include a node embedding sub-network 111 and an edge embedding sub-network 112. At each time step, the encoder 110 can be configured to process data defining the current state of the physical environment 102 to generate a representation of the current state of the physical environment 102 that can represent. e.g., a graph 114. A “graph” (e.g., G=(V, E)) refers to a data structure that includes a set of nodes V and edges E, such that each edge connects a respective pair of nodes.

In addition to the data representing the current state of the physical environment 102, the input into the node embedding sub-network 111 can also include global features 106 of the physical environment, e.g., one or more forces being applied to the physical environment, a gravitational constant of the physical environment, a magnetic field in the physical environment, or any other appropriate feature or a combination thereof. Specifically, at each time step, the global features 106 can be concatenated onto the node features associated with each node in the graph 114, before the node embedding sub-network 111 processes the node features to generate an embedding for the node.

After generating the graph 114 that represents the current state of the physical environment 102 at the time step, the simulation system 100 provides data defining the graph 114 to the updater 120, which updates the graph 114 over a number of internal update iterations to generate an updated graph 115 for the time step.

“Updating” a graph refers to, at each update iteration, performing a step of message-passing (e.g., a step of propagation of information) between the nodes and edges included in the graph by, e.g., updating the node and/or edge embeddings for some or all nodes and edges in the graph based on node and/or edge embeddings of neighboring nodes in the graph. In other words, at each update iteration, the updater 120 maps an input graph, e.g., G^{t}=(V, E), onto an output graph G^{t+1}=(V,E), where the output graph may have the same structure as the input graph (e.g., the same nodes V and edges E) but different node and edge embeddings.

More specifically, the updater 120 can include a node updating sub-network 121 and an edge updating sub-network 122, e.g. each comprising a multi-layer perceptron (MLP). At each update iteration, the node updating sub-network 121 can process the current node embedding for a node included in the graph 114, and the respective current edge embedding for each edge that is connected to the node in the graph 114, to generate an updated node embedding for the node. Further, at each update iteration, the edge updating sub-network 122 can process the current edge embedding for the edge and the respective current node embedding for each node connected by the edge to generate an updated edge embedding for the edge. For example, the updated edge embedding e′_{i,j} of an edge connecting node i to node j, and the updated node embedding v′ᵢ of node i, can be represented as:

$$\begin{matrix}{e}_{i , j}^{′} ← {f}^{e} ( {e}_{i , j} , {v}_{i} , {v}_{j} ) & {v}_{i}^{′} ← {f}^{v} ( {v}_{i} , {\sum }_{j} {e}_{i , j}^{′} )\end{matrix} \qquad ( 1 )$$

where f^{e} and f^{v} represent the operations performed by the edge updating sub-network 122 and the node updating sub-network 121, respectively.

The final update iteration of the updater 120 generates data defining the final updated graph 115 for the time step. Data defining the updated graph 115 can be provided to the decoder 130 of the simulation system 100. The decoder 130 is a neural network that is configured to process a node embedding associated with a node in a graph to generate one or more dynamics features 116 for the node. At each time step, the decoder 130 can be configured to process a respective node embedding for each node in the updated graph 115 (e.g., updated node embeddings) to generate a respective dynamics feature 116 corresponding to each node in the updated graph 115.

The node and edge embedding sub-networks (111, 112), the node and edge updating sub-networks (121, 122), and the decoder 130 can have any appropriate neural network architectures that enables them to perform their described function. For example, they can have any appropriate neural network layers (e.g., convolutional layers, fully connected layers, recurrent layers, attention layers, etc.) in any appropriate numbers (e.g., 2 layers, 5 layers, or 10 layers) and connected in any appropriate configuration (e.g., as a linear sequence of layers).

The system 100 can provide data defining the dynamics features 116 associated with nodes in the updated graph 115 to a prediction engine 160. The prediction engine 160 is configured to process dynamics features 116 associated with nodes in a graph to generate the next state of the physical environment 140.

Accordingly, at each time step, the simulation system 100 can process the current state of the physical environment 102 and generate the next state of the physical environment 140.

At each time step, the system 100 can provide the next state of the physical environment 140 as the current state of the physical environment 102 at the next time step. The system 100 can repeat this process over multiple time steps and thereby generate a trajectory of predicted states that simulate the states of the physical environment.

As described above, the simulation system 100 can be used to simulate physical environments represented as a mesh, e.g., a mesh that spans the environment, or a mesh that represents one or more objects in the environment.

To simulate such systems, at each time step, the simulation system 100 can process data defining the current state of the physical environment 102, where such data specifies a mesh, generate a graph 114 based on the mesh, update the graph 114 over a number of update iterations to generate an updated graph 115, and predict the next state of the physical environment 140 based on the updated graph 115. Various aspects of this process will be described in more detail next.

Physical environments that include, e.g., continuous fields, deformable materials, rigid objects, and/or complex structures, can be represented by a mesh M^{t}=(V, E^{M}). A “continuous field” generally refers to, e.g., a spatial region associated with a physical quality (e.g., velocity, pressure, etc.) that varies continuously across the region. For example, each spatial location in a velocity field can have a particular value of velocity associated with it.

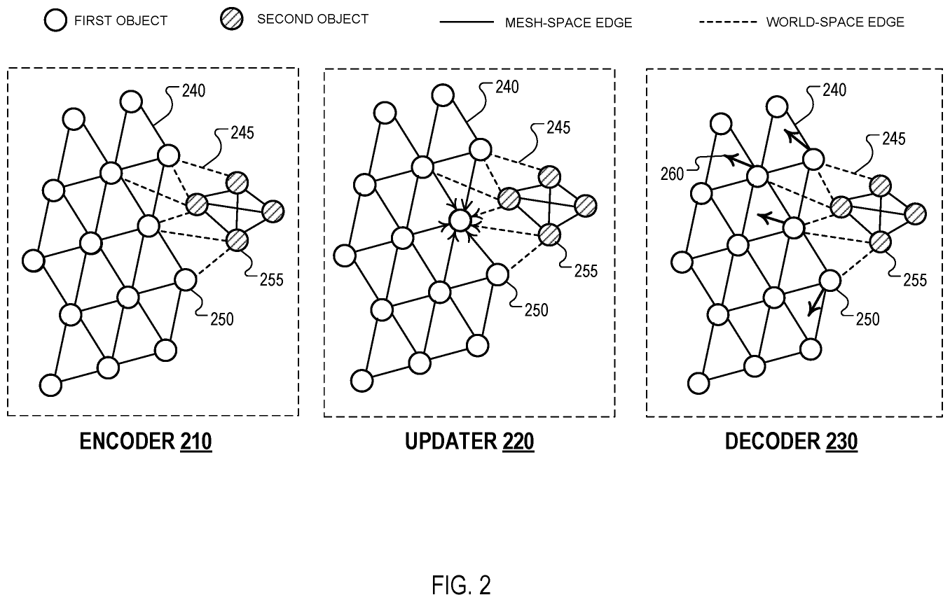

Generally, a “mesh” refers to a data structure that includes multiple mesh nodes V and mesh edges E^{M}, where each mesh edge E^{M} connects a pair of mesh nodes. The mesh can define an irregular (unstructured) grid that specifies a tessellation of a geometric domain (e.g., a surface, or space) into smaller elements (e.g., cells, or zones) having a particular shape, e.g., a triangular shape, or a tetrahedral shape. Each mesh node can be associated with a respective spatial location in the physical environment. In some implementations, the mesh can represent a respective surface of one or more objects in the environment. In some implementations, the mesh can span (e.g., cover) the physical environment, e.g., if the physical environment represents a continuous field, e.g., a velocity or pressure field. Examples of a mesh representation of a physical environment will be described in more detail below with reference to FIG. 2.

Each mesh node in a mesh can be associated with current mesh node features that characterize a current state of the physical environment at a position in the environment corresponding to the mesh node. For example, in implementations that involve simulations of physical environments with objects, each mesh node can represent a point on an object and can be associated with object-specific mesh node features that characterize, e.g., one or more of the point's finite-difference velocity, the distance from the point to one or more domain boundaries, e.g., the floor or another object, and so on.

Generally, mesh representations are not limited to the aforementioned physical systems and other types of physical systems can also be represented through a mesh and simulated using the simulation system 100.

In all implementations, the mesh node features associated with each mesh node can further include a respective state of the mesh node at each of one or more previous time steps.

As described above, the simulation system 100 can be used to process data defining the current state of the physical environment 102 (e.g., represented by a mesh e.g., M^{t}=(V, E^{M})) and generate data defining a prediction of the next state of the physical environment 140.

Specifically, at each time step, an encoder 110 can process the current state 102 to generate a graph 114 by assigning a graph node to each mesh node V included in the mesh M^{t}. Further, for each pair of mesh nodes V that are connected by a mesh edge, the encoder 110 can instantiate an edge, referred to as a mesh-space edge E^{M}, between the corresponding pair of nodes in the graph 114.

In some implementations, the encoder 110 can augment the edges in the mesh by using world edges. In particular, in these implementations, the encoder 110 can process data defining the mesh and identify each pair of mesh nodes V in the mesh that have respective spatial positions which are separated by less than a threshold distance in world-space W (e.g., in the reference frame of the physical environment) and instantiate an edge, referred to as a world-space edge E^{W}, between each corresponding pair of nodes in the graph 114. In particular, the encoder 110 is configured to instantiate world-space edges between pairs of graph nodes that are not already connected by a mesh-space edge.

In other words, the encoder 110 can transform a mesh M^{t}=(V, E^{M}) into a corresponding graph G=(V, E^{M}, E^{W}) that includes nodes V, and where some pairs of nodes are connected by mesh-space edges E^{M}, and some pairs of nodes are connected by world-space edges E^{W}. Representing the current state of the physical environment 102 through both mesh-space edges and world-space edges allows the system 100 to simulate interactions between a pair of mesh nodes that are substantially far removed from each other in mesh-space (e.g., that are separated by multiple other mesh nodes and mesh edges) but are substantially close to each other in world-space (e.g., that have proximate spatial locations in the reference frame of the physical environment). In particular, including world-space edges in the graph allows more efficient message-passing between spatially-proximate graph nodes and thus allows more accurate simulation using fewer update iterations (i.e., message-passing steps) in the updater 120, thus reducing consumption of computational resources during simulation.

In addition to generating the graph 114, the encoder 110 of the system 100 can generate node and edge embeddings associated with the nodes and edges in the graph 114, respectively.

Specifically, at each time step, the node embedding sub-network 111 of the encoder 110 can process features associated with each node in the graph 114 (e.g., mesh node features), and generate a respective current node embedding for each node in the graph 114.

Optionally, in addition to the data representing the current state of the physical environment 102, the input into the node embedding sub-network 111 can also include global features 106 of the physical environment, e.g., forces being applied to the physical environment, a gravitational constant of the physical environment, a magnetic field of the physical environment, or any other appropriate feature or a combination thereof. At each time step, the global features 106 can be concatenated onto the node features associated with each node in the graph 114, before the node embedding sub-network 111 processes the node features to generate an embedding for the node.

At each time step, the graph neural network 150 can generate an edge embedding for each edge in the graph 114. For example, for each mesh-space edge E^{M} in the graph 114, a mesh-space edge embedding sub-network of the graph neural network 150 can process features associated with the pair of graph nodes that are connected by the mesh-space edge E^{M} (edge features), and generate a respective current edge embedding for the mesh-space edge.

Specifically, the edge features for a given edge can include any of: respective positions of the mesh nodes corresponding to the graph nodes connected by the edge in the graph, a distance between the respective positions of the mesh nodes corresponding to the graph nodes connected by the mesh-space edge in the graph, a magnitude of the distance, or a combination thereof.

In some implementations, the edge features for a given edge can include a distance between the two mesh nodes connected by the edge in an initial, undeformed mesh that represents object parts of objects in the environment, a magnitude of the distance, or both. For example, the initial mesh can be the mesh at one of the initial time steps, e.g., the first initial time step or the last initial time step. That is, the initial mesh can represent actual (or initial) shapes of the underlying objects in the environment rather than those simulated by the system. Including these features can assist the system in maintaining the rigid shape of objects throughout the simulation.

Similarly, at each time step, for each world-space edge E^{W} in the graph 114, a world-space edge embedding sub-network of the graph neural network can process features of the world-space edge, i.e., associated with the pair of graph nodes that are connected by the world-space edge E^{W}, and generate a respective current edge embedding for the world-space edge.

The world-space edges can generally have the same features as the mesh edges, e.g., respective positions of the mesh nodes corresponding to the graph nodes connected by the edge in the graph, a distance between the respective positions of the mesh nodes corresponding to the graph nodes connected by the edge in the graph, a magnitude of the distance, or a combination thereof. Like the mesh edges, the world-space edges can also include features from the initial mesh.

Accordingly, at each time step, the encoder 110 can process the mesh and generate the graph 114 G=(V, E^{M},E^{W}) with associated graph node embeddings, mesh-space edge embeddings and, in some implementations, also world-space edge embeddings.

After generating data defining the graph 114, at each time step, the simulation system 100 can provide the graph 114 to the updater 120 that can update the graph 114 over multiple internal update iterations to generate the final updated graph 115 for the time step.

As described above, at each update iteration, the node updating sub-network 121 of the updater 120 can process an input that includes (i) the current node embedding for the node, and (ii) the respective current edge embedding for each edge that is connected to the node, to generate an updated node embedding for the node.

In implementations where the graph 114 includes mesh-space edges and world-space edges, the edge updating sub-network 122 of the updater 120 can include a mesh-space edge updating sub-network and a world-space edge updating sub-network. At each update iteration, the mesh-space edge updating sub-network can be configured to process an input that includes: (i) the current edge embedding for the mesh-space edge, and (ii) the respective current node embedding for each node connected by the mesh-space edge, to generate an updated edge embedding for the mesh-space edge. Further, at each update iteration, the world-space edge updating sub-network can be configured to process an input that includes: (i) the current edge embedding for the world-space edge, and (ii) the respective current node embedding for each node connected by the world-space edge, to generate an updated edge embedding for the world-space edge.

For example, the updated mesh-space edge embedding

$${e}_{i , j}^{′ M}$$

of a mesh-space edge connecting node i to node j, the updated world-space edge embedding

$${e}_{i , j}^{′ W}$$

of a world-space edge connecting node i to node j, and the updated node embedding v′ᵢ of node i, can be generated as:

$${e}_{i , j}^{′ M} ← {f}^{M} ( {e}_{i , j}^{M} , {v}_{i} , {v}_{j} ) {e}_{i , j}^{′ W} ← {f}^{W} ( {e}_{i , j}^{W} , {v}_{i} , {v}_{j} ) \qquad ( 3 )$$

$${v}_{i}^{′} ← {f}^{v} ( {v}_{i} , {\sum }_{j} {e}_{i , j}^{′ M} , {\sum }_{j} {e}_{i , j}^{′ W} )$$

The mesh-space edge updating sub-network (f^{M}), the world-space edge updating subnetwork (f^{W}) and the node updating sub-network (f^{V}) can have any appropriate neural network architectures that enables them to perform their described function. For example, they can include any appropriate neural network layers (e.g., convolutional layers, fully connected layers, recurrent layers, attention layers, etc.) connected in any appropriate configuration (e.g., as a linear sequence of layers): merely as a particular example they may each be implemented using an MLP with a residual connection.

In some cases, each update of message passing can be implemented by a respective message passing block. Thus the graph neural network can be implemented as a set of L identical message passing blocks each with a separate set of network parameters. That is, the message passing blocks can be identical, i.e. have the same neural network architecture, but each can have a separate set of neural network parameters. Each message block can implement the mesh-space edge updating sub-network, the world-space edge updating subnetwork, and the node updating sub-network defined by Equation 3. i.e. a mesh-space edge updating sub-network to process and update a mesh-space edge embedding, a world-space edge updating subnetwork to process and update a world-space edge embedding, and a node updating sub-network to process and update a node embedding and the updated mesh-space and world-space edge embeddings. The message passing blocks can then be applied sequentially. i.e. each (except for the first which receives the current input graph) being applied to the output of the previous block to process the data defining the graph over multiple iterations.

The final update iteration of the updater 120 generates data representing the final updated graph 115 for the time step. At each time step, data defining the updated graph 115 can be provided to the decoder 130. The decoder 130 processes node embeddings associated with each node in the graph 115 and generates one or more dynamics features 116 for each node that characterize a rate of change of a mesh node feature of the mesh node corresponding to the graph node in the graph 115. The dynamics features 116 can represent a rate of change of any appropriate mesh node feature from the updated graph 115, e.g., position, velocity, acceleration, momentum, density, or any other appropriate physical aspect. As a particular example, the dynamics features 116 for a given mesh node can represent a finite-difference acceleration estimate for the node.

At each time step, the prediction engine 160 can determine a mesh node feature at the next time step based on: (i) the mesh node feature of the mesh node at the current time step, and (ii) the rate of change of the mesh node feature by, e.g., integrating the rate of change of the mesh node feature any appropriate number of times. For example, for first-order systems, the prediction engine 160 can determine the position

$${q}_{i}^{t + 1}$$

of the mesh node i at the next time step based on the position

$${q}_{i}^{t}$$

of the mesh node i at the current time step and the dynamics feature pᵢ corresponding to the mesh node i as:

$${q}_{i}^{t + 1} = {p}_{i} + {q}_{i}^{t} \qquad ( 4 )$$

Similarly, for second-order systems, the prediction engine 160 can determine the position

$${q}_{i}^{t + 1}$$

of the mesh node i at the next time step based on the position

$${q}_{i}^{t}$$

of the mesh node i at the current time step, the position

$${q}_{i}^{t - 1}$$

of the mesh node i at the previous time step, and the dynamics feature pᵢ corresponding to the mesh node i as:

$${q}_{i}^{t + 1} = {p}_{i} + 2 {q}_{i}^{t} - {q}_{i}^{t - 1} \qquad ( 5 )$$

Accordingly, by determining mesh node features for all mesh nodes at the next time step, the simulation system 100 can determine the next state of the physical environment 140.

In some implementations, updating the mesh node features for the mesh nodes directly using equation (5) for long rollouts that are required for many of the use cases can cause positional errors to accumulate and deform the object shape. The system can prevent this by using shape matching during rollouts. That is, after each step, the system can fit a transformation to the predicted node positions, and re-project the nodes to the transformed mesh to enforce shape consistency.

This is described in more detail below.

A training engine can train the graph neural network 150 by using, e.g., supervised learning techniques on a set of training data. The training data can include a set of training examples, where each training example can specify: (i) a training input that can be processed by the graph neural network 150, and (ii) a target output that should be generated by the graph neural network 150 by processing the training input. The training data can be generated by, e.g., a ground-truth physics simulator (e.g., physics engine), or in any other appropriate manner e.g. from captured real-world data. For example, training data for a particular simulated physical environment may be obtained from the real-world environment that is being simulated, by capturing observations of the dynamics of the environment, e.g. observations of the motion of one or more objects in the real-world environment. These observations may be obtained from one or more cameras, or using tags (e.g. TagSLAM Pfrommer et al., arXiv: 1910.00679), or in any other convenient manner.

At each training iteration, the training engine can sample a batch of one or more training examples from the training data and provide them to the graph neural network 150 that can process the training inputs specified in the training examples to generate corresponding outputs. The training engine can evaluate an objective function that measures a similarity between: (i) the target outputs specified by the training examples, and (ii) the outputs generated by the graph neural network, e.g., a cross-entropy or squared-error objective function. Specifically, the objective function L can be based on the predicted per-node accelerations

$${a}_{i}^{t}$$

as follows:

$$L ( {x}_{i}^{t} ; θ ) = {‖ {d}_{θ} ( {x}_{i}^{t} ) - {a}_{i}^{t} ‖}^{2} \qquad ( 6 )$$

where d_{θ} is the graph neural network model and θ represents the parameter values of the graph neural network 150. The training engine can determine gradients of the objective function, e.g., using backpropagation techniques, and can update the parameter values of the graph neural network 150 using the gradients, e.g., using any appropriate gradient descent optimization algorithm, e.g., Adam. The training engine can determine a performance measure of the graph neural network on a set of validation data that is not used during training of the graph neural network 150.

After training of the graph neural network 150, the system 100 can be used to simulate the state of different types of physical environments that can exhibit discontinuous dynamics. For example, from single time step predictions during training, the system 100 can effectively generalize to different types of physical environments, different initial conditions, thousands of time steps, and at least an order of magnitude more mesh nodes.

FIG. 2 illustrates operations performed by an encoder module, an updater module, and a decoder module of a physical environment simulation system (e.g., the system 100 in FIG. 1) on a graph representing a mesh when world-space edges are used. Specifically, the encoder 210 generates a representation of the current state of the physical environment (e.g., transforms a mesh into the graph), the updater 220 performs multiple steps of message passing (e.g., updates the graph), and decoder 230 extracts dynamics features corresponding to the nodes in the graph.

The graphs include a set of nodes, represented by circles (250, 255), and a set of edges, represented by lines (240, 245), where each edge connects two nodes. The graphs 200 may be considered simplified representations of the physical environment (an actual graph representing the environment may have far more nodes and edges than are depicted in FIG. 2).

In this illustration, the physical environment includes a first object and a second object, where the objects can interact with each other (e.g., collide). The first object is represented by nodes 250 that are depicted as a set of empty circles, and the second object is represented by nodes 255 that are depicted as a set of hatched circles 255. The nodes 250, corresponding to the first object, are connected by mesh-space edges 240 (E^{M}) that are depicted as solid lines. The nodes 255, corresponding to the second object, are also connected by mesh-space edges 240 (E^{M}). In addition to mesh-space edges, the graphs further include world-space edges 245 (E^{W}) that are depicted as dashed lines. The world-space edges 245 connect the nodes 250 representing the first object with the nodes 255 representing the second object. In particular, the world-space edges 245 can allow to simulate external dynamics such as, e.g., collisions, that are not captured by internal mesh-space interactions.

As described above, the encoder 210 generates a representation of the current state of the physical environment. In this illustration, the encoder 210 generates a graph that represents two objects and includes nodes, mesh-space edges, and world-space edges. The updater 220 performs message-passing between the nodes and edges in the graph. In particular, as described above, the updater 220 updates node embeddings and edge embeddings based on the node and edge embeddings of neighboring nodes and edges, respectively. For example, as shown in FIG. 2, a node embedding is updated based on the node embeddings of each of the neighboring nodes, and edge embeddings of all edges that connect the node to all neighboring nodes. After the last update iteration, the updater 220 generates an updated graph.

The decoder 230 processes the updated graph and extracts dynamics features 260 of each node in the graph. For example, in this illustration, the dynamics features 260 can be an acceleration corresponding to each mesh node represented by the nodes in the graph. The acceleration can be a result of, e.g., a collision of the first object with the second object. From the dynamics features, the simulation system 100 can determine the next state of the physical environment, e.g., the positions of mesh nodes that represent the first object and the second object.

FIG. 3 illustrates an example simulation of a physical environment 300 generated by a physical environment simulation system (e.g., the system 100 in FIG. 1) relative to the ground truth states of the physical environment 300.

In particular, the example of FIG. 3 shows a 2D projection of a sample ground truth 3D trajectory 302 of a cube being tossed onto a table (orange) and the predictions 304 obtained by the system 100 given the same initial state. The cube contacts the table along an edge, bouncing into the air. The dotted line 306 shows the time of contact at which discontinuous dynamics occur, i.e., a velocity discontinuity is introduced by the rigid contact event. As can be seen the graph in part (b) of FIG. 3, the system 100 is capable of representing and correctly resolving the velocity discontinuity introduced by the rigid contact event (dashed line), closely matching the ground truth.

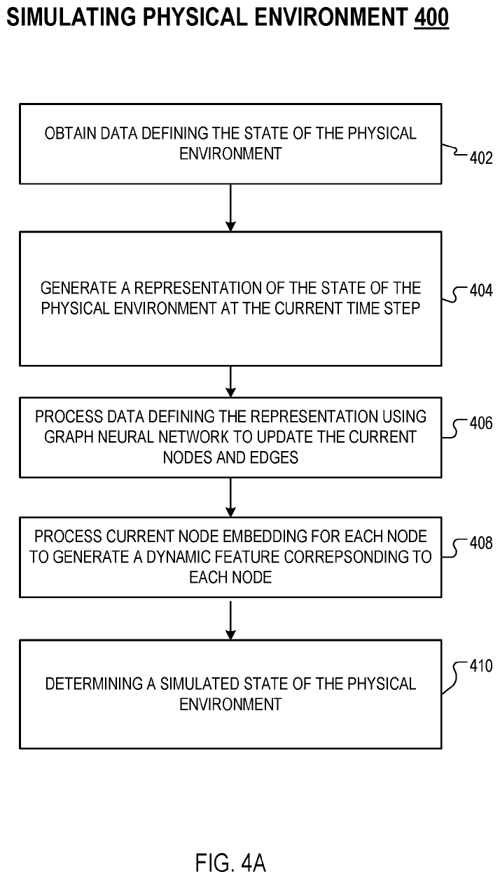

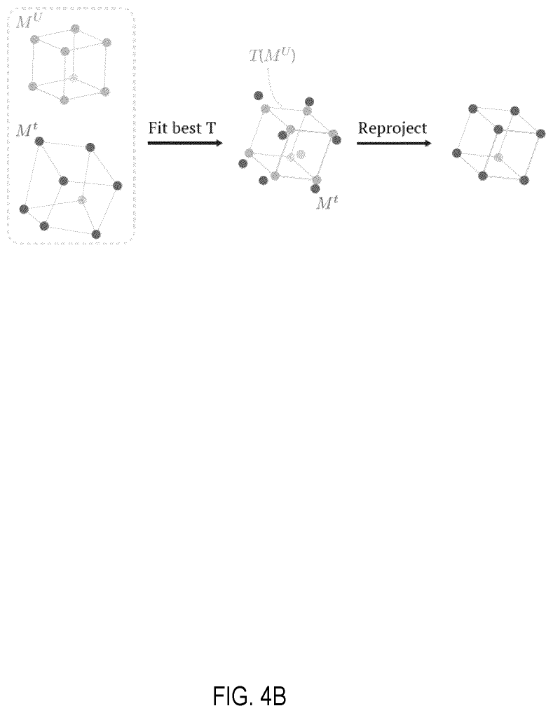

FIG. 4A is a flow diagram of an example process 400 for simulating a state of a physical environment. For convenience, the process 400 will be described as being performed by a system of one or more computers located in one or more locations. For example, a physical environment simulation system, e.g., the simulation system 100 of FIG. 1, appropriately programmed in accordance with this specification, can perform the process 400.

The system obtains data defining the state of the physical environment at one or more initial time steps (402). For example, the system can obtain the data defining the state of the physical environment at the one or more initial time steps by obtaining data generated from one or more sensor readings of sensors measuring the physical environment, e.g. data representing positions or motion of one or more objects in the environment, such as data an image sensor such as a camera or LIDAR sensor, or tag location data from one or more tags. As another example, the system can obtain the data defining the state of the physical environment at the one or more initial time steps, e.g., by randomly initializing a simulation of a particular scene in the physical environment or receiving an input from a user specifying a scene in the physical environment that needs to be simulated.

Generally, the data defining the state of the physical environment at any given time step includes data defining a mesh including multiple mesh nodes and multiple mesh edges. Each mesh node can be associated with respective mesh node features and each mesh edge can be associated with respective mesh edge features.

The system then generates data defining a respective simulated state of the physical environment at each current time step in a time interval following the one or more initial time steps. As described above, the data defining the respective simulated state of the physical environment at any given current time step are the respective node features and edge features for the nodes and edges of the mesh.

Generally, the environment has discontinuous dynamics at one or more time steps during the time interval. For example, the discontinuous dynamics are caused at least in part by rigid contact occurring during the time interval. As another example, the discontinuous dynamics are caused at least in part by one or more frictional transitions occurring during the time interval.

To generate the data defining the respective simulated state, the system performs steps 404-410 at each current time step.

The system generates a representation of the state of the physical environment at the current time step (step 404). The representation includes a respective current node embedding for each of the mesh nodes and a respective current edge embedding for each of the mesh edges. In particular, the system uses the node embedding subnetwork and the edge embedding subnetwork(s) to process features of the nodes and edges as of the state of the environment at the current time step to generate the respective current node embedding for each of the mesh nodes and a respective current edge embedding for each of the mesh edges as described above.

The system processes data defining the representation using a graph neural network to update the current node embedding of each mesh node and the current edge embedding of each mesh edge (step 406).

After the updating, the system processes the respective current node embedding for each mesh node in the mesh to generate a respective dynamics feature corresponding to each mesh node (step 408) and determines a simulated state of the physical environment at a next time step based on: (i) the dynamics features corresponding to the mesh nodes, and (ii) the state of the physical environment at the current time step (step 408).

In some implementations, to determine the simulated state at the next time step, the system determines a respective initial predicted position at the next time step for each of the mesh nodes based on: (i) the dynamics features corresponding to the mesh nodes, and (ii) the state of the physical environment at the current time step. In particular, the system generates these predicted positions as described above with reference to FIG. 1.

The system generates, from the respective initial predicted positions, a respective updated predicted position at the next time step for each of the mesh nodes to preserve rigidity of object shapes of objects in the environment.

To generate the updated predicted positions, the system can determine a transformation, in particular a rigid transformation, optionally an optimal rigid transformation, to transform an initial mesh representing object shapes of the objects in the environment to the respective initial predicted positions for the mesh nodes. The transformation may be referred to as a rigid transformation as it may transform each of the mesh nodes in a corresponding manner, e.g. maintaining their respective relative positions (as opposed to a transformation that distorts the object). The transformation may be referred to as optimal as it may be a rigid transformation that is a best fit to the initial mesh and to the initial prediction positions for the mesh nodes determined by the graph neural network. This may be a rigid transformation that, when applied to the initial mesh, most closely represents the initial prediction positions for the mesh nodes, according to any suitable metric of fit, e.g. based on a distance between transformed node initial mesh positions and the initial prediction positions.

That is, the system can determine the rigid transformation that optimally transforms the initial mesh representing object shapes of objects in the environment to the respective initial prediction positions for the mesh nodes determined by the graph neural network.

The initial mesh can be the mesh at one of the initial time steps, e.g., the first initial time step or the last initial time step. That is, the initial mesh can represent actual (or initial) shapes of the underlying objects in the environment.

As a particular example, the system can determine, from the set of “rigid” transformations that can be represented as a combination of a translation operation and a rotation operation, the optimal transformation, i.e., the one that results in the minimum total displacement between the respective initial predicted positions for the mesh nodes determined by the graph neural network and the position of the mesh node in an updated mesh generated by applying the optimal rigid transformation to the initial mesh.

In other words, the system can determine the rotation matrix R and the translation vector t and t₀ which minimize:

$${\sum }_{i} {{w}_{i} ( R ( {x}_{i}^{0} - {t}_{0} ) + t - {x}_{i} )}^{2}$$

where the sum is over the mesh nodes i in the mesh, wᵢ is a weight assigned to the mesh node i, xᵢ is the initial predicted position assigned to the mesh node i, and xᵢ⁰ is the initial position assigned to the mesh node i in the initial, undeformed mesh. The system can perform this minimization using any appropriate computational technique. The weights for the mesh nodes can be the same, e.g., each equal to one, or can be assigned based on an input received from a user.

For each mesh node, the system sets the respective updated prediction position of the mesh node equal to a position of the mesh node in an updated mesh generated by applying the optimal rigid transformation to the initial mesh. Thus, the system constrains the updates to rigid objects in the environment at any given time step to conform to a rigid transformation, thereby preserving the rigidity of the object shapes across time steps.

FIG. 4B illustrates the shape matching process described above.

In the simplified example of FIG. 4B, the mesh represents a cube and has six nodes. At a given time step, the system has determined, e.g., by performing the process 400, an updated mesh M^{t} from an initial mesh M^{u}. Rather than directly setting the updated positions of the mesh nodes to the predicted positions in the updated mesh Mt, the system first fits the best rigid transformation T, i.e., the rigid transformation that when applied to the initial mesh M^{u} results in a transformed mesh T(M^{u}) that best fits the updated mesh M^{t}. The system then sets the respective updated prediction position of each mesh node equal to a position of the mesh node in an updated mesh generated by applying the optimal rigid transformation to the initial mesh, i.e., equal to the position of the mesh node in the transformed mesh T(M^{u}).

As described above, each node in the graph representing the state of the physical environment at the current time step can correspond to a respective mesh node. The mesh can, e.g., span the physical environment and/or represent one or more objects in the physical environment.

For example, for each mesh node, the mesh node features can include a state of the mesh node at the current time step, including, e.g., positional coordinates (spatial positions) representing a position of the mesh node in a frame of reference of the mesh at the current time step, positional coordinates representing a position of the mesh node in a frame of reference of the physical environment at the current time step, or both.

Furthermore, the system can, optionally, for one or more time steps, determine a respective set of one or more re-meshing parameters for each mesh node of the mesh, and adapt a resolution of the mesh based on the re-meshing parameters by, e.g., splitting one or more edges in the mesh, collapsing one or more edges in the mesh, or both. In such implementations, determining a respective set of one or more re-meshing parameters for each mesh node of the mesh can include, after the updating, processing the respective current node embedding for each graph node using a re-meshing neural network to generate the respective re-meshing parameters for the mesh node corresponding to the graph node.

In some implementations, the system can identify, based on the re-meshing parameters, one or more mesh edges of the mesh that should be split. This can include, for one or more mesh edges, determining an oriented edge length of the mesh edge using the re-meshing parameters for a mesh node connected to the mesh edge, and in response to determining that the oriented edge length of the mesh edge exceeds a threshold, determining that the mesh edge should be split. The system can also identify, based on the re-meshing parameters, one or more mesh edges of the mesh that should be collapsed. This can include, for one or more mesh edges, determining, using the re-meshing parameters, an oriented edge length of a new mesh edge that would be created by collapsing the mesh edge, and in response to determining that the oriented edge length of the new mesh edge does not exceed a threshold, determining that the mesh edge should be collapsed.

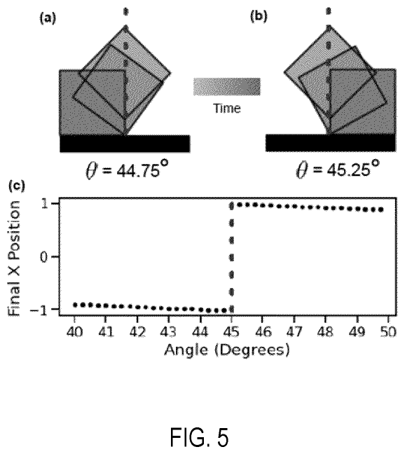

FIG. 5 illustrates an example of the sensitivity of the simulations generated by the system 100 to initial conditions. In particular, FIG. 5 shows a scenario in which a cube is falling directly downwards with a rotation angle close to 45 degrees. This scenario is discontinuous because, for any angle less than 45 degrees, the cube will fall to the left, while for any greater than 45 degrees, the cube will fall to the right. Here the model must be acutely sensitive to rotations differing by fractions of a degree, as these will significantly affect the final position of the cube. From the Figure, it is clear that the graph network simulator closely captures the discontinuous behavior in this diagnostic scenario: even for barely perceptible deviations of 0.25 degrees, the simulator correctly predicts the final position of the block. This further underscores the ability of the learned model to handle sharp discontinuities and multi-modal dynamics without producing smoothed interpolations of the training data.

One advantage of implementations of the above described systems and methods is that they can be configured for hardware acceleration. In such implementations, the method is performed by data processing apparatus comprising one or more computers and including one or more hardware accelerator units. For example, the hardware accelerator units can be any of a variety of different computer chips that have special-purpose hardware for performing specific operations, e.g., matrix multiplication, matrix-vector multiplication, and so on, in hardware. Examples of these types of accelerators include machine-learning hardware accelerators, machine-learning inference hardware accelerators, or other types of hardware accelerator comprising a plurality of processors adapted for matrix multiplication. For example, the accelerators can be, e.g., one or more GPUs (Graphics Processing Units) or TPUs (Tensor Processing Units).

Such implementations involve updating the graph at each of one or more update iterations including updating the graph using a processor system comprising L message passing blocks, where each message passing block can have the same neural network architecture and a separate set of neural network parameters. The method can further include applying the message passing blocks sequentially to process the data defining the graph over multiple iterations, and using the one or more hardware accelerators to apply the message passing blocks sequentially to process the data defining the graph. In some implementations, the processing is performed using the message passing blocks, i.e. the processor system is distributed over the hardware accelerators. Thus there is provided a simulation method which is specifically adapted for implementation using hardware accelerators units, unlike some conventional approaches which are not capable of taking advantage of hardware acceleration.

The system can be used to predict physical quantities based on measured real-world data. Thus in some implementations of the above described systems and methods the physical environment comprises a real-world environment including a real, physical object. Then obtaining the data defining the state of the physical environment at the current time step may comprise obtaining, from the physical object, object data defining a 2D or 3D representation of a shape of the physical object. For example, an image of the object may be captured by a camera such as a depth camera. The method may then involve inputting interaction data defining an interaction of the physical object with the real-world environment. For example, the interaction data may define the shape of a second physical object, such as an actuator, which will interact with the physical object and may apply a force to the physical object; or it may define a force applied to the physical object; or it may define a field such as a velocity, momentum, density or pressure field that the physical object is subjected to.

In some implementations of the above described systems and methods, as previously described, the described systems and methods may also be used for real-world control, in particular optimal control tasks, e.g. to assist a robot in manipulating a deformable or rigid object. Thus, as previously described, the physical environment may comprise a real-world environment including a physical object e.g. an object to be picked up or manipulated. Determining the state of the physical environment at the next time step includes determining a representation of a shape or configuration of the physical object e.g. by capturing an image of the object. Determining the state of the physical environment at the next time step may comprise determining a predicted representation of the shape or configuration of the physical object e.g. when subject to a force or deformation e.g. from an actuator of a robot. The method may further comprise controlling the robot using the predicted representation to manipulate the physical object, e.g. using the actuator, towards a target location, shape or configuration of the physical object by controlling the robot to optimize an objective function dependent upon a difference between the predicted representation and the target location, shape or configuration of the physical object. Controlling the robot may involve providing control signals to the robot based on the predicted representation to cause the robot to perform actions, e.g. using an actuator of the robot, to manipulate the physical object to perform a task. For example, this may involve controlling the robot, e.g. the actuator, using a reinforcement learning process with a reward that is at least partly based on a value of the objective function, to learn to perform a task which involves manipulating the physical object.

In some implementations of the above described systems and methods, the described systems and methods can be used to design, test, or otherwise evaluate a product using the simulator, e.g., using simulated states of the environment. The product can then be made or manufactured based on the results of the simulator, e.g., to have the properties of the product that was simulated, e.g., using any appropriate manufacturing technique. For example, the system can be used to model interactions between different components of a mechanical apparatus, e.g. gears of a car or parts of a combustion engine. The use of the system can enable accurate modeling of discontinuous frictional relationships or contacts between components of the product or external surfaces, e.g., frictional relationships between brakes and a wheel or a wheel, or simulating collisions interactions of the product with other objects or the ground. Thus, the simulator can be used to “stress test” a product design under real-world scenarios that result in discontinuous dynamics before the product is manufactured. If the product design passes the stress test, a product having the design can be manufactured.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few:

Computer-readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more data processing apparatus for simulating states of a physical environment, the method comprising:
obtaining data defining the state of the physical environment at one or more initial time steps, wherein the data defining the state of the physical environment at a given time step represents a mesh of the environment at the given step, wherein the mesh comprises a plurality of mesh nodes and a plurality of mesh edges, and wherein the data defining the state of the environment comprises respective mesh node features for each of the mesh nodes and respective mesh edge features for each of the mesh edges; and
generating data defining a respective simulated state of the physical environment at each current time step in a time interval following the one or more initial time steps, wherein the environment has discontinuous dynamics at one or more time points during the time interval, and wherein the generating comprises, at each current time step in the time interval:
generating a representation of the state of the physical environment at the current time step, the representation comprising a respective current node embedding for each of the mesh nodes and a respective current edge embedding for each of the mesh edges;
processing data defining the representation using a graph neural network to update the current node embedding of each mesh node and the current edge embedding of each mesh edge;
after the updating, processing the respective current node embedding for each mesh node in the mesh to generate a respective dynamics feature corresponding to each mesh node; and
determining a simulated state of the physical environment at a next time step based on: (i) the dynamics features corresponding to the mesh nodes, and (ii) the state of the physical environment at the current time step.

2. The method of claim 1, wherein the discontinuous dynamics are caused at least in part by rigid contact occurring during the time interval.

3. The method of claim 1, wherein the discontinuous dynamics are caused at least in part by one or more frictional transitions occurring during the time interval.

4. The method of claim 1, wherein determining a simulated state of the physical environment at a next time step based on: (i) the dynamics features corresponding to the mesh nodes, and (ii) the state of the physical environment at the current time step comprises:
determining a respective initial predicted position at the next time step for each of the mesh nodes based on: (i) the dynamics features corresponding to the mesh nodes, and (ii) the state of the physical environment at the current time step; and
generating, from the respective initial predicted positions, a respective updated predicted position at the next time step for each of the mesh nodes to preserve rigidity of object shapes of objects in the environment.

5. The method of claim 4, wherein generating, from the respective initial predicted positions, a respective updated predicted position at the next time step for each of the nodes in the graph to preserve rigidity of object shapes represented in the graph comprises:
determining an optimal rigid transformation to transform an initial mesh representing object shapes of the objects in the environment to the respective initial predicted positions for the mesh nodes; and
for each mesh node, setting the respective updated prediction position of the mesh node equal to a position of the mesh node in an updated mesh generated by applying the optimal rigid transformation to the initial mesh.

6. The method of claim 5, wherein the optimal rigid transformation is a combination of a translation operation and a rotation operation.

7. The method of claim 1, wherein the mesh spans the physical environment.

8. The method of claim 1, wherein the mesh represents one or more objects in the physical environment.

9. The method of claim 1, wherein for each of the plurality of mesh nodes, the mesh node features associated with the mesh node comprise a state of the mesh node at the current time step, and wherein the state of the mesh node at the current time step comprises: positional coordinates representing a position of the mesh node in a frame of reference of the mesh at the current time step, positional coordinates representing a position of the mesh node in a frame of reference of the physical environment at the current time step, or both.

10. The method of claim 9, wherein for each of the plurality of mesh nodes, the mesh node features associated with the mesh node further comprise a respective state of the mesh node at each of one or more previous time steps.

11. The method of claim 1, wherein generating the representation of the state of the physical environment at the current time step comprises generating a respective current node embedding for each mesh node in the graph, comprising, for each mesh node:
processing an input comprising one or more of the features of the mesh node using a node embedding sub-network of the graph neural network to generate the current node embedding for the mesh node.

12. The method of claim 11, wherein for each mesh node, the input to the node embedding sub-network further comprises one or more global features of the physical environment.

13. The method of claim 12, wherein the global features of the physical environment comprise forces being applied to the physical environment, a gravitational constant of the physical environment, a magnetic field of the physical environment, or a combination thereof.

14. The method of claim 1, wherein the mesh edges comprise a plurality of mesh-space edges and a plurality of world-space edges, wherein generating the representation of the state of the physical environment at the current time step comprises:
for each pair of mesh nodes that are connected by an edge in the mesh, determining that the corresponding pair of graph nodes are connected by a mesh-space edge in the representation; and
for each pair of mesh nodes that have respective positions which are separated by less than a threshold distance in a frame of reference of the physical environment, determining that the corresponding pair of graph nodes are connected by a world-space edge in the representation.

15. The method of claim 14, wherein generating the representation of the state of the physical environment at the current time step comprises generating a respective current edge embedding for each mesh edge, comprising, for each mesh-space edge in the graph:
processing an input comprising: respective positions of the mesh nodes corresponding to the nodes connected by the mesh-space edge, data characterizing a difference between the respective positions of the mesh nodes corresponding to the nodes connected by the mesh-space edge, or a combination thereof, using a mesh-space edge embedding sub-network of the graph neural network to generate the current edge embedding for the mesh-space edge.

16. The method of claim 14, further comprising, for each world-space edge in the graph:
processing an input comprising: respective positions of the mesh nodes connected by the world-space edge, data characterizing a difference between the respective positions of the mesh nodes connected by the world-space edge in the graph, or a combination thereof, using a world-space edge embedding sub-network of the graph neural network to generate the current edge embedding for the world-space edge.

17. The method of claim 9, wherein the mesh node features further comprise a distance from the position of the mesh node to one or more domain boundaries.

18. The method of claim 1, wherein the mesh edge features comprise a distance between the two mesh nodes connected by the edge in an initial, undeformed mesh that represents object parts of objects in the environment.

19. The method of claim 1, wherein processing the respective current node embedding for each node in the graph to generate the respective dynamics feature corresponding to each node in the graph comprises, for each graph node:
processing the current node embedding for the graph node using a decoder sub-network of the graph neural network to generate the respective dynamics feature for the graph node, wherein the dynamics feature characterizes a rate of change of a mesh node feature of the mesh node corresponding to the graph node.

20. The method of claim 1, wherein obtaining data defining the state of the physical environment at one or more initial time steps comprises:
obtaining data generated from one or more sensor readings of sensors measuring the physical environment.

21. The method of claim 1, further comprising:
evaluating a control policy for an agent interacting with objects in the real-world environment using the simulated states of the physical environment.

22. The method of claim 1, further comprising:
training a control policy for an agent interacting with objects in the real-world environment using the simulated states of the physical environment.

23. The method of claim 21, further comprising:
deploying the control policy for controlling the agent in the physical environment.

24. The method of claim 21, wherein the agent is a robot.

25. The method of claim 21, wherein processing data defining the representation using a graph neural network is performed by one or more hardware accelerator units.

26. The method of claim 25, wherein the one or more hardware accelerator units apply respective message passing blocks of the graph neural network to update the data defining the representation.

27-29. (canceled)

30. One or more non-transitory computer storage media storing instructions that when executed by one or more computers cause the one or more computers to perform operations for simulating states of a physical environment, the operations comprising:
obtaining data defining the state of the physical environment at one or more initial time steps, wherein the data defining the state of the physical environment at a given time step represents a mesh of the environment at the given step, wherein the mesh comprises a plurality of mesh nodes and a plurality of mesh edges, and wherein the data defining the state of the environment comprises respective mesh node features for each of the mesh nodes and respective mesh edge features for each of the mesh edges; and
generating data defining a respective simulated state of the physical environment at each current time step in a time interval following the one or more initial time steps, wherein the environment has discontinuous dynamics at one or more time points during the time interval, and wherein the generating comprises, at each current time step in the time interval:
generating a representation of the state of the physical environment at the current time step, the representation comprising a respective current node embedding for each of the mesh nodes and a respective current edge embedding for each of the mesh edges;
processing data defining the representation using a graph neural network to update the current node embedding of each mesh node and the current edge embedding of each mesh edge;
after the updating, processing the respective current node embedding for each mesh node in the mesh to generate a respective dynamics feature corresponding to each mesh node; and
determining a simulated state of the physical environment at a next time step based on: (i) the dynamics features corresponding to the mesh nodes, and (ii) the state of the physical environment at the current time step.

31. A system comprising:
one or more computers; and
one or more storage devices communicatively coupled to the one or more computers, wherein the one or more storage devices store instructions that, when executed by the one or more computers, cause the one or more computers to perform operations for simulating states of a physical environment, the operations comprising:
obtaining data defining the state of the physical environment at one or more initial time steps, wherein the data defining the state of the physical environment at a given time step represents a mesh of the environment at the given step, wherein the mesh comprises a plurality of mesh nodes and a plurality of mesh edges, and wherein the data defining the state of the environment comprises respective mesh node features for each of the mesh nodes and respective mesh edge features for each of the mesh edges; and
generating data defining a respective simulated state of the physical environment at each current time step in a time interval following the one or more initial time steps, wherein the environment has discontinuous dynamics at one or more time points during the time interval, and wherein the generating comprises, at each current time step in the time interval:
generating a representation of the state of the physical environment at the current time step, the representation comprising a respective current node embedding for each of the mesh nodes and a respective current edge embedding for each of the mesh edges;
processing data defining the representation using a graph neural network to update the current node embedding of each mesh node and the current edge embedding of each mesh edge;
after the updating, processing the respective current node embedding for each mesh node in the mesh to generate a respective dynamics feature corresponding to each mesh node; and
determining a simulated state of the physical environment at a next time step based on: (i) the dynamics features corresponding to the mesh nodes, and (ii) the state of the physical environment at the current time step.

32-34. (canceled)
